(19) United States
(12) Patent Application Publication
(10) Pub. No.: US 2022/0155626 A1
(43) Pub. Date: May 19, 2022

(54) SYSTEM, INCUBATOR, AND ILLUMINANCE ADJUSTING METHOD

(71) Applicant: NIHON KOHDEN CORPORATION, Tokyo (JP)

(72) Inventors: Fumihiko MURAYAMA, Tokorozawa-shi (JP); Kenichi ASHIZAWA, Tokorozawa-shi (JP); Shuhei MORINAGA, Tokorozawa-shi (JP)

(21) Appl. No.: 17/453,570

(22) Filed: Nov. 4, 2021

(30) Foreign Application Priority Data
Nov. 13, 2020 (JP) 2020-189573

(51) Int. Cl. G02F 1/133; A61G 11/00; H05B 47/105

(52) U.S. Cl. CPC G02F 1/13306; A61G 11/00; A61G 2203/10; A61G 2203/30; H05B 47/105

(57) ABSTRACT

A system having an acquirer configured to acquire physiological information of a subject; a determiner configured to determine whether the subject has stress or not based on the physiological information acquired by the acquirer; and a controller configured to adjust illuminance around the subject based on a result of the determination.

### CROSS-REFERENCE TO RELATED APPLICATIONS

The present application claims priority from Japanese Patent Application No. 2020-189573, filed Nov. 13, 2020, the entire content of which is incorporated herein by reference.

### TECHNICAL FIELD

The presently disclosed subject matter relates to a system, an incubator, and an illuminance adjusting method.

### BACKGROUND

A neonate weighing less than 2500 g is regarded as a low-birth-weight infant. The neonate is urged to grow in an incubator that can create an artificial environment close to an environment within a womb. The incubator has functions such as heat retention, humidification, oxygen supply, and infection prevention, and creates a favorable environment for the growth of the neonate.

WO 2019-157202 discloses the incubator. Adjusting the electric current applied to a film can vary the level of opacity of the incubator. The level of the opacity is adjusted based on physiological information measured by an ECG sensor or the like attached to a neonate inside the incubator in order to adjust circadian rhythm of the neonate.

However, the neonate may be stressed by illuminance around the neonate. Therefore, there is a possibility that the load of the stress has an undesirable impact on development of the neonate.

### SUMMARY

Therefore, the presently disclosed subject matter is provided with a system, an incubator, and an illuminance adjusting method that can achieve a light environment suppressing stress of a subject.

A system includes: an acquirer configured to acquire physiological information of a subject; a determiner configured to determine whether the subject has stress or not based on the physiological information acquired by the acquirer; and a controller configured to adjust illuminance around the subject based on a result of the determination of the determiner.

An incubator includes: an acquirer configured to acquire physiological information of a subject; a determiner configured to determine whether the subject has stress or not based on the physiological information acquired by the acquirer; and a controller configured to adjust illuminance around the subject based on a result of the determination of the determiner.

An illuminance adjusting method includes: acquiring physiological information of a subject; determining whether the subject has stress or not based on the acquired physiological information; and adjusting illuminance around the subject when determination has been made that the subject has the stress.

### BRIEF DESCRIPTION OF DRAWINGS

FIG. 1 is a block diagram illustrating a hardware configuration of an illuminance control system.

FIG. 2 is a perspective diagram illustrating external appearance of an incubator when transmission of light into a hood is not blocked by an electronic curtain.

FIG. 3 is a perspective diagram illustrating the external appearance of the incubator when the transmission of the light into the hood is suppressed by the electronic curtain.

FIG. 4 is a block diagram illustrating functions of a controller.

FIG. 5 is an explanatory diagram illustrating an example of the illuminance control system in a case where incubators are disposed in one room and illuminance is controlled for each of the incubators.

FIG. 6 is a flow chart for explaining operation of the illuminance control system.

FIG. 7 is an explanatory diagram illustrating an example of the illuminance control system in which brightness of a lighting device is changed so as to control the illuminance.

FIG. 8 is a block diagram illustrating a first modification of the hardware configuration of the illuminance control system.

FIG. 9 is a block diagram illustrating a second modification of the hardware configuration of the illuminance control system.

FIG. 10 is a flow chart for explaining operation of the illuminance control system according to any of the modifications.

### DESCRIPTION OF EMBODIMENT

A system, an incubator, and an illuminance adjusting method according to an embodiment of the presently disclosed subject matter will be described below in detail with reference to the drawings. Incidentally, in each of the drawings, like constituent elements will be designated by like reference signs correspondingly and respectively, and duplicate description thereof will be omitted. In addition, dimensional proportions in the drawings may be exaggerated for convenience of explanation and differ from actual proportions.

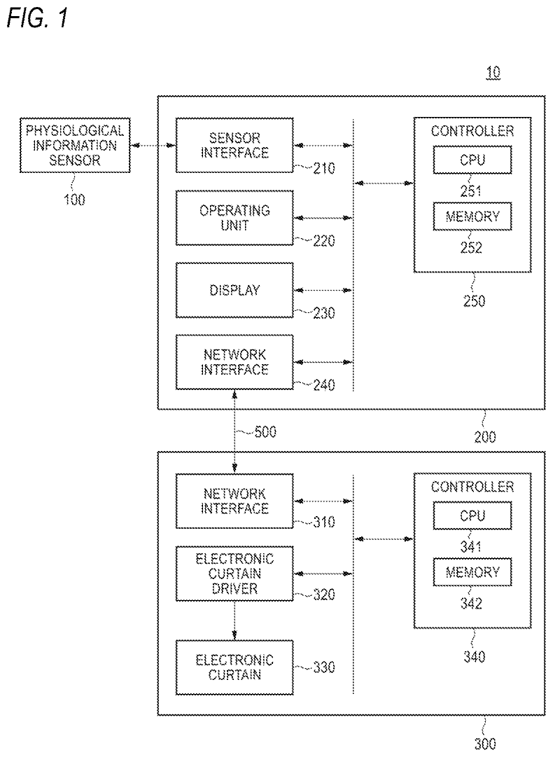

FIG. 1 is a block diagram illustrating a hardware configuration of an illuminance control system 10.

The illuminance control system 10 includes a physiological information sensor 100, a physiological monitor 200, and an incubator 300.

(Physiological Information Sensor 100)

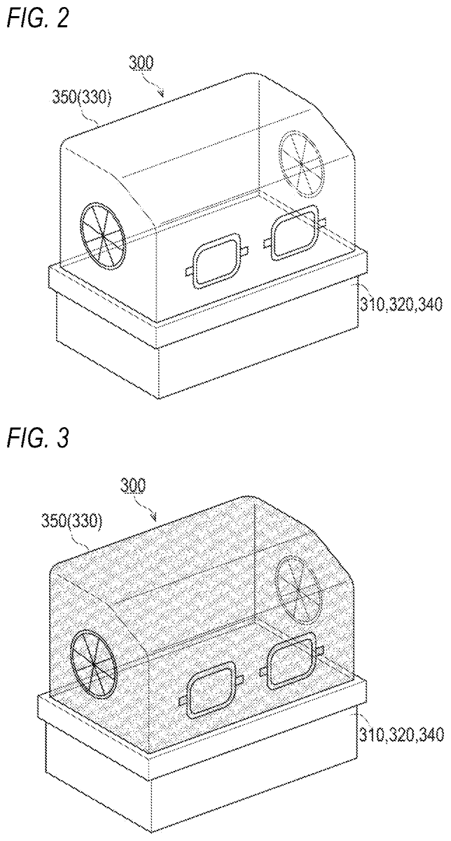

The physiological information sensor 100 detects physiological information of a subject 900 inside a hood 350 (see FIG. 2) of the incubator 300. The physiological information includes physiological information that depends on stress of the subject. The physiological information includes physiological information directly detected by the sensor 100 and physiological information calculated from the detected information. For example, the sensor 100 is an ECG sensor or an SpO2 sensor, and the physiological information includes at least one of an ECG, an R-R interval, a heart rate, an oxygen saturation (SpO2) in arterial blood, a pulse, and an LF/HF which will be described later. The R-R interval and the heart rate are calculated from the ECG (ECG waveform) detected by the ECG sensor, which is an example of the sensor 100. The R-R interval is a distance between an R wave and a next R wave in the ECG. The SpO2 and the pulse can be calculated from a pulse waveform detected by the SpO2 sensor, which is another example of the sensor 100. The subject 900 is, for example, a neonate. In order to make description simple, the description will be made below on the assumption that the sensor 100 is the ECG sensor and the physiological information is the R-R interval, except as otherwise noted. The sensor 100 is attached to the subject 900 inside the hood 350 of the incubator 300.

By frequency analysis (e.g. Fast Fourier Transform (FFT)) of the R-R interval, heart rate variability (HRV) of the subject 900 can be obtained, so that an LF/HF, which is a ratio of an LF (a low-frequency component of the heart rate variability) to an HF (a high-frequency component of the heart rate variability) to indicate autonomic nerve fluctuation can be calculated. The HF can be a peak of intensity of a power spectrum of the R-R interval in a high frequency band (e.g. 0.15 Hz to 0.40 Hz) or an integrated value of the intensity. The LF can be a peak of intensity of the power spectrum of the R-R interval in a low frequency band (e.g. 0.05 Hz to 0.15 Hz) or an integrated value of the intensity. The LF/HF is an index (physiological information) that reflects stress of the subject 900. When the value of the LF/HF is larger, it indicates that the stress is greater. Incidentally, it is considered that, for example, the heart rate or the pulse also reflects the stress. It is considered that the larger the value of the heart rate or the pulse is, the greater the stress is. It is considered that the SpO2 also reflects the stress. It is considered that the smaller the value of the SpO2 is, the greater the stress is.

(Physiological Monitor 200)

The physiological monitor 200 includes a sensor interface 210, an operating unit 220, a display 230, a network interface 240, and a controller 250. These constituent elements are communicably connected to one another through a bus.

The sensor interface 210 is an interface for communicably connecting the physiological monitor 200 to the physiological information sensor 100 by wire or wireless. For example, the sensor interface 210 can include an input terminal, an antenna, and a front-end circuit or the like. Incidentally, when the sensor interface 210 is replaced by the network interface 240, the sensor interface 210 may be omitted. In this case, the physiological monitor 200 can be connected to the physiological information sensor 100 through a network 500.

The operating unit 220 is constituted by, for example, a touch panel and various keys. The operating unit 220 is used for various operations by a user.

The display 230 is, for example, a liquid crystal display to display various information including the ECG.

The network interface 240 is an interface for communicably connecting the physiological monitor 200 to an apparatus connected to the network 500. By the network interface 240, the physiological monitor 200 can be communicably connected to the incubator 300 through the network 500. For example, the network interface 240 can include an input terminal, an antenna, and a front-end circuit or the like. The communication standard between the physiological monitor 200 and the incubator 300 is, for example, Wi-Fi (registered trademark), Bluetooth (registered trademark), or 5G. The network 500 is, for example, an LAN (Local Area Network), a WAN (Wide Area Network), or the like.

The controller 250 that can be constituted by one or more CPUs (Central Processing Unit) 251 and one or more memories 252 controls the respective constituent elements of the physiological monitor 200 in accordance with a program, and processes various data.

The controller 250 calculates the R-R interval based on the ECG received through the sensor interface 210. A plurality of successive R-R intervals in time may be calculated from the ECG.

The controller 250 transmits the calculated R-R interval to the incubator 300 through the network interface 240.

(Incubator 300)

The incubator 300 can include a network interface 310, an electronic curtain driver 320, an electronic curtain 330, and a controller 340. The constituent elements, i.e. the network interface 310, the electronic curtain driver 320, and the controller 340, are communicably connected to one another through a bus. The incubator 300 constitutes a system.

The network interface 310 is an interface for communicably connecting the incubator 300 to an apparatus connected to the network 500. By the network interface 310, the incubator 300 can be communicably connected to the physiological monitor 200 through the network 500. Since the specific configuration of the network interface 310 is similar to or the same as that of the network interface 240 of the physiological monitor 200, description thereof will be omitted.

The electronic curtain driver 320 drives the electronic curtain 330 provided in the hood 350 of the incubator 300. The electronic curtain driver 320 outputs a drive voltage (or a drive current) corresponding to light transmittance of the electronic curtain 330 to the electronic curtain 330 so as to change the light transmittance of the electronic curtain 330.

The electronic curtain 330 can be, for example, a liquid crystal dimming film whose light transmittance is fine-tuned according to the drive voltage. The incubator 300 can include one or more electronic curtains.

FIG. 2 is a perspective diagram illustrating external appearance of the incubator 300 when transmission of light into the hood 350 is not blocked by the electronic curtain 330. FIG. 3 is a perspective diagram illustrating the external appearance of the incubator 300 when the transmission of the light into the hood is suppressed by the electronic curtain 330. The subject 900 inside the hood 350 is not shown in FIG. 2 and FIG. 3.

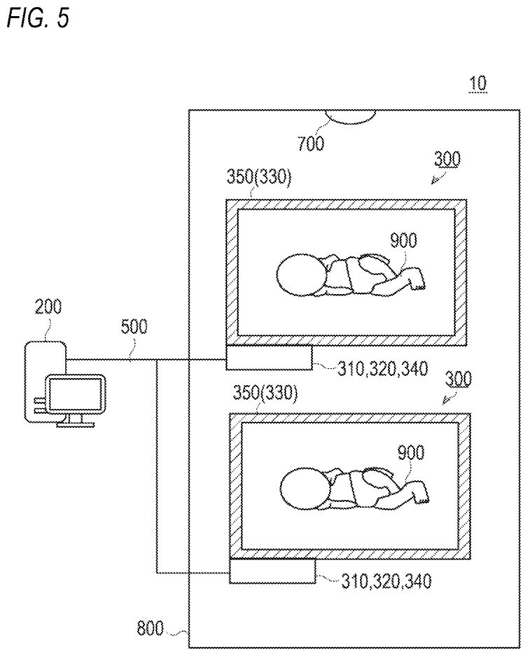

In the example of FIG. 2, transmission of light emitted from a lighting device 700 (see FIG. 5) or the like into the hood 350 is not blocked by the electronic curtain 330. In other words, illuminance around the subject 900 inside the hood 350 is not reduced. In the example of FIG. 3, the transmission of the light emitted from the lighting device 700 or the like into the hood 350 is suppressed by the electronic curtain 330. In other words, the illuminance around the subject 900 inside the hood 350 is reduced. In FIG. 3, an area around the subject 900 where the illuminance has been reduced is illustrated in gray color. The illuminance around the subject 900 that is controlled, for example, by changing the light transmittance of the electronic curtain 330 will be hereinafter also simply referred to as “illuminance control”.

The controller 340 that can include a CPU 341 and a memory 342 controls the respective constituent elements of the incubator 300 according to a program, and processes various data.

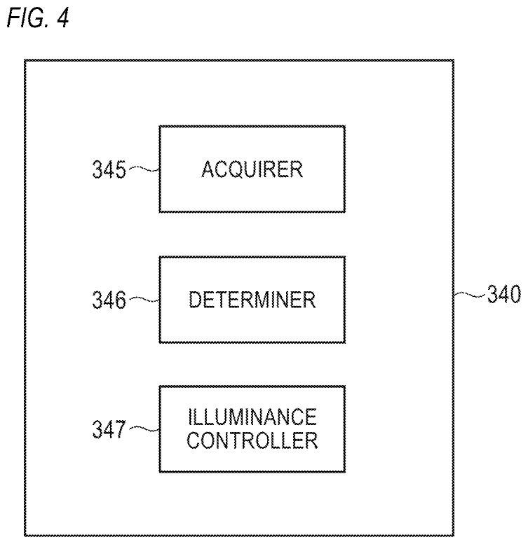

FIG. 4 is a block diagram illustrating functions of the controller 340. The controller 340 functions as an acquirer 345, a determiner 346, and an illuminance controller 347.

The acquirer 345 receives the R-R interval from the physiological monitor 200 through the network interface 310 so as to acquire the R-R interval.

The determiner 346 calculates the aforementioned LF/HF based on the R-R interval. The determiner 346 determines whether the subject 900 has stress or not based on the LF/HF. Specifically, the determiner 346 can determine that the subject 900 has the stress when the LF/HF is larger than or equal to a predetermined threshold, or can determine that the subject 900 does not have the stress when the LF/HF is smaller than the predetermined threshold. For example, the predetermined threshold can be set to an appropriate value by experiments or the like in consideration of the LF/HF when it is considered that the subject does not have the stress (e.g. during sleeping) and the LF/HF when it is considered that the subject has the stress (e.g. during crying). The predetermined threshold may be set to an appropriate value based on experience.

The determiner 346 may use machine learning to determine the stress of the subject 900 from the physiological information. For example, the determiner 346 learns a neural network using a relatively large amount of training data including a combination of an ECG when it is considered that the subject 900 does not have the stress (e.g. during sleeping) and a ground truth label (data indicating “absence of the stress”) and a combination of an ECG when it is considered that the subject 900 has the stress (e.g. during crying) and a ground truth label (data indicating “presence of the stress”). The determiner 346 may use the learned neural network (learned model) to estimate (determine) the presence/absence of the stress from the ECG of the subject 900. Incidentally, it is preferable that the training data are acquired for a plurality of subjects 900.

When determination has been made that the subject 900 has the stress, the illuminance controller 347 performs illuminance control to reduce the light transmittance of the electronic curtain 330 so as to reduce the illuminance around the subject 900 until determination is made that the subject 900 does not have the stress. The illuminance controller 347 performs illuminance control to output a control signal to the electronic curtain driver 320 so as to allow the electronic curtain driver 320 to reduce the light transmittance of the electronic curtain 330. The illuminance controller 347 constitutes a controller.

FIG. 5 is an explanatory diagram illustrating an example of the illuminance control system 10 in a case where a plurality of incubators 300 are disposed in one room 800 and illuminance is controlled on each of the incubators 300. In FIG. 5, physiological information sensors 100 attached to subjects 900 respectively are not illustrated.

In the example of FIG. 5, the incubators 300 are respectively connected to a physiological monitor 200 through a network 500. In addition, the not-illustrated physiological information sensors 100 are respectively connected to the physiological monitor 200 by wireless or by cable or the like.

A lighting device 700 is installed in a ceiling or the like of the room 800, and keeps illuminance in the entire room 800 at a substantially constant level.

The physiological monitor 200 receives ECG information from each of the incubators 300, calculates an R-R interval from the ECG waveform, and transmits the R-R interval to the incubator 300 from which the ECG was transmitted. The incubator 300 calculates an LF/HF based on the R-R interval received from the physiological monitor 200, and controls illuminance individually and independently. As a result, even in the case where the incubators 300 are disposed in one room 800 and the lighting device 700 is shared by the incubators 300, illuminance control can be performed on each of the incubators 300 to reduce stress of a subject 900 inside a hood 350 of the incubator 300.

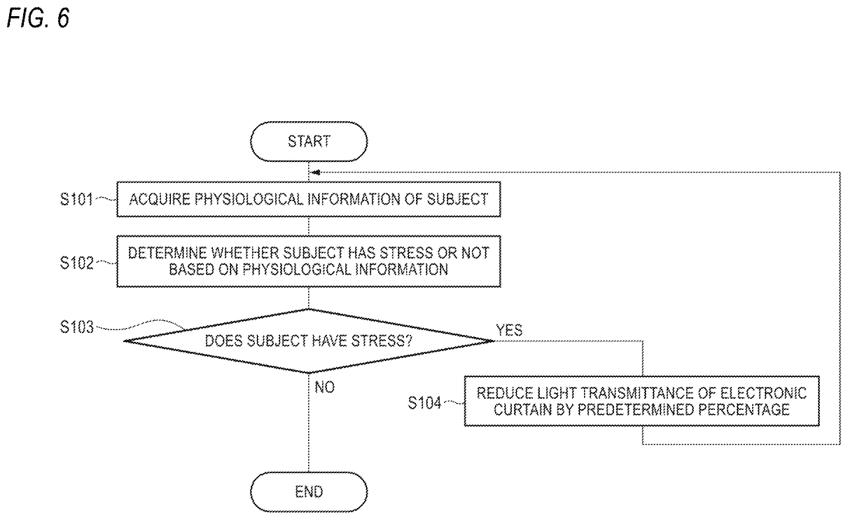

FIG. 6 is a flow chart for explaining operation of the illuminance control system 10. This flow chart can be executed in accordance with a program by cooperative operation between the controller 250 of the physiological monitor 200 and the controller 340 of the incubator 300. To make description simple, the description will be made below in a case in which the controller 340 of the incubator 300 controls the respective constituent elements of the incubator 300 and the physiological monitor 200 according to the program by way of example.

The controller 340 receives an R-R interval from the physiological monitor 200 so as to acquire the R-R interval (S101). The R-R interval is physiological information calculated by the physiological monitor based on an ECG of a subject 900 received from the physiological information sensor 100.

The controller 340 determines whether the subject 900 has stress or not based on the R-R interval (S102). Specifically, for example, the controller 340 calculates an LF/HF from the R-R interval. Then, the controller 340 determines that the subject 900 has the stress when the calculated LF/HF is larger than or equal to a predetermined threshold, or determines that the subject 900 does not have the stress when the LF/HF is smaller than the predetermined threshold.

Having determined that the subject 900 does not have the stress (S103: NO), the controller 340 terminates the processing.

Having determined that the subject 900 has the stress (S103: YES), the controller 340 outputs a control signal to the electronic curtain driver 320 to allow the electronic curtain driver 320 to reduce light transmittance of the electronic curtain 330 by a predetermined percentage (S104). The predetermined percentage can be, for example, any percentage in a range of 5% to 50%. Then, the controller 340 repeats the steps S101 to S104 until the controller 340 determines that the subject 900 does not have the stress in the step S103. In this manner, illuminance around the subject 900 is reduced by illuminance control until determination is made that the subject 900 does not have the stress.

### Modifications

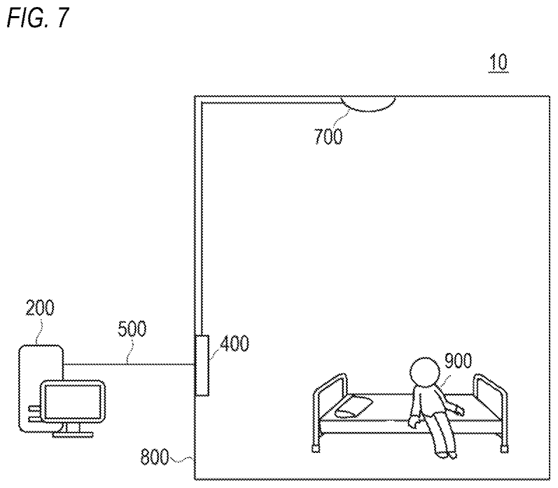

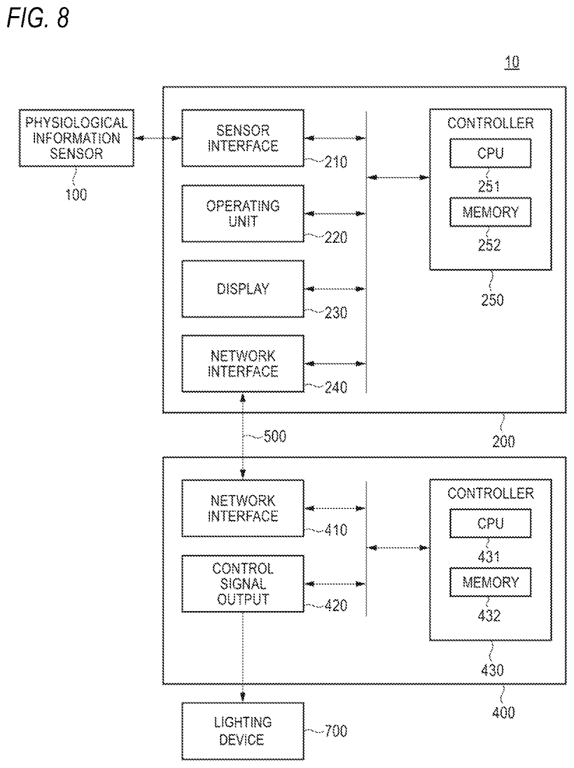

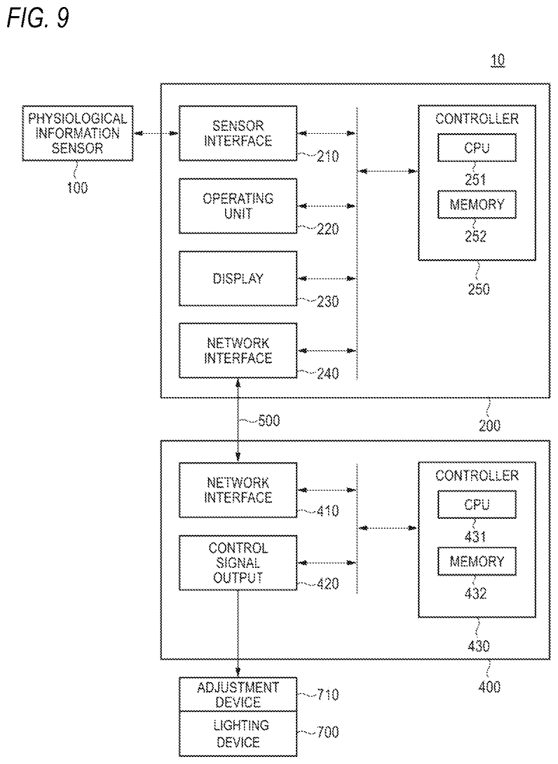

FIG. 7 is an explanatory diagram illustrating an example of the illuminance control system 10 in which brightness of the lighting device 700 is changed so as to control illuminance. FIG. 8 is a block diagram illustrating a first modification of the hardware configuration of the illuminance control system 10. FIG. 9 is a block diagram illustrating a second modification of the hardware configuration of the illuminance control system 10. In FIG. 7, a physiological information sensor 100 attached to each subject 900 is not illustrated as in FIG. 5. In FIG. 8 and the like, description about parts in common with those in the hardware configuration of the illuminance control system 10 illustrated in FIG. 1 will be omitted.

In the example of FIG. 8, the illuminance control system 10 is provided with one or more physiological information sensors 100, a physiological monitor 200, a lighting control system 400, and a lighting device 700.

The lighting control system 400 is provided with a network interface 410, a control signal output 420, and a controller 430. The network interface 410, the control signal output 420, and the controller 430 are communicably connected to one another through a bus. The lighting control system 400 constitutes a system.

The control signal output 420 outputs a control signal for controlling brightness of the lighting device 700 to the lighting device 700.

The lighting device 700 reduces the brightness by a predetermined percentage in accordance with the control signal received from the control signal output 420.

The second modification of the illuminance control system 10 illustrated in FIG. 9 differs from the first modification illustrated in FIG. 8 at the following points. That is, the second modification is provided with an adjustment device 710, a control signal for controlling brightness of the lighting device 700 is transmitted to the adjustment device 710, and the adjustment device 710 reduces the brightness of the lighting device 700 based on the control signal. Since the second modification is similar to or the same as the first modification except the aforementioned points, description thereof will be omitted.

In the second modification, the control signal output 420 outputs, to the adjustment device 710, the control signal for controlling the brightness of the lighting device 700. In a case where, for example, an adjustment mechanism (e.g. a dial) for adjusting the brightness of the lighting device 700 by hand or the like is provided in the lighting device 700, the adjustment device 710 displaces the adjustment mechanism. When, for example, the adjustment mechanism is a dial, the adjustment device 710 turns the dial in accordance with the control signal so as to change the brightness of the lighting device 700. The adjustment device 710 can be constituted by, for example, a controller such as a CPU, a rotation mechanism that can rotate in engagement with the aforementioned dial, and a motor or the like that rotates the rotation mechanism.

The adjustment device 710 displaces the adjustment mechanism of the lighting device 700 in accordance with the control signal received from the control signal output 420, so as to reduce the brightness of the lighting device 700 by a predetermined percentage.

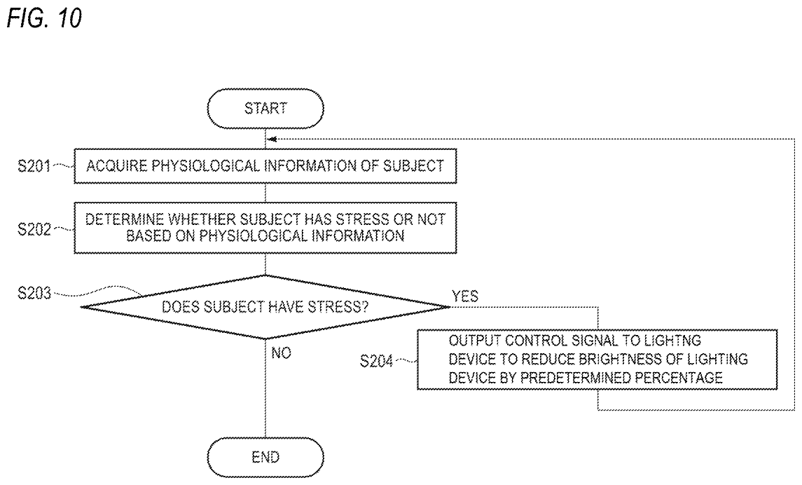

FIG. 10 is a flow chart for explaining operation of the illuminance control system 10 according to any of the modifications. This flow chart can be executed according to a program by cooperative operation between the controller 250 of the physiological monitor 200 and the controller 430 of the lighting control system 400. In order to make description simple, the description will be made below in a case where the controller 430 of the lighting control system 400 controls the respective constituent elements of the lighting control system 400 and the physiological monitor 200 according to the program by way of example.

The controller 430 receives an R-R interval from the physiological monitor 200 so as to acquire the R-R interval (S201). The R-R interval is physiological information calculated by the physiological monitor based on an ECG of a subject 900 received from a physiological information sensor 100.

The controller 430 determines whether the subject 900 has stress or not based on the R-R interval (S202). Specifically, for example, the controller 430 calculates an LF/HF from the R-R interval. Then, the controller 430 determines that the subject 900 has the stress when the calculated LF/HF is larger than or equal to a predetermined threshold, or determines that the subject 900 does not have the stress when the LF/HF is smaller than the predetermined threshold.

Having determined that the subject 900 does not have the stress (S203: NO), the controller 430 terminates the processing.

Having determined that the subject 900 has the stress (S203: YES), the controller 430 controls the control signal output 420 to transmit a control signal to the lighting device 700 or the like, so as to reduce brightness of the lighting device 700 by a predetermined percentage (S204). The predetermined percentage can be, for example, any percentage in a range of 5% to 50%. Then, the controller 430 repeats the steps S201 to S204 until the controller 430 determines that the subject 900 does not have the stress in the step S203. In this manner, illuminance around the subject 900 is reduced by illuminance control until determination is made that the subject 900 does not have the stress.

Based on the physiological information, determination is made as to whether the subject has the stress or not. The illuminance around the subject is adjusted based on a result of the determination. In this manner, it is possible to achieve a light environment that suppresses the stress of the subject.

Further, an ECG, an R-R interval, a heart rate, an SpO2, or a pulse detected from the subject is received so that the ECG, the R-R interval, the heart rate, the SpO2, or the pulse is acquired as the physiological information. Thus, it is possible to achieve a light environment that suppresses the stress of the subject simply and appropriately.

Furthermore, the light transmittance of the electronic curtain of the incubator used by the subject is controlled so that the illuminance is controlled. Thus, it is possible to achieve a light environment that suppresses the stress of the subject simply and at low cost.

Furthermore, when determination has been made that the subject has the stress, the illuminance is reduced until determination is made that the subject does not have the stress. Thus, it is possible to achieve a light environment that suppresses the stress of the subject more accurately.

Furthermore, a control signal is outputted to the lighting device or the controller of the lighting device so as to adjust the illuminance. Thus, it is possible to achieve a light environment that simply and appropriately suppresses the stress of the subject who is, for example, receiving medical treatment at home. In particular, it is possible to provide a new solution for a patient who has an intractable disease to have difficulty in controlling his/her body, such as an ALS patient.

Although the embodiment of the presently disclosed subject matter has been described above in detail, the presently disclosed subject matter is not limited to the aforementioned embodiment.

For example, some or all of the functions realized by the program in the aforementioned embodiment may be realized by hardware such as a circuit.

In addition, the configuration and functions of the physiological monitor 200 may be designed to be included in the configuration and functions of the incubator 300, or the functions of the physiological monitor 200 may be modularized and integrated with the incubator 300.

Some steps may be omitted from the aforementioned flow chart, or other steps may be added to the aforementioned flow chart. Some of the steps may be executed simultaneously, or one step may be divided into a plurality of steps and executed.

According to the above disclosure, determination is made as to whether the subject has stress or not based on the physiological information. The illuminance around the subject is adjusted based on the result of the determination. In this manner, it is possible to achieve a light environment that suppresses the stress of the subject.

What is claimed is:

1. A system comprising:
an acquirer configured to acquire physiological information of a subject;
a determiner configured to determine whether the subject has stress or not based on the acquired physiological information; and
a controller configured to adjust illuminance around the subject based on a result of the determination of the determiner.

2. The system according to claim 1, wherein:
the acquirer is configured to receive at least one of an ECG, an R-R interval, a heart rate, an SpO2, and a pulse detected from the subject, so as to acquire the at least one of ECG, the R-R interval, the heart rate, the SpO2, and the pulse as the physiological information.

3. The system according to claim 1, wherein:
the controller is configured to control light transmittance of an electronic curtain of an incubator used by the subject, so as to adjust the illuminance.

4. The system according to claim 1, wherein:
when determination has been made by the determiner that the subject has the stress, the controller is configured to reduce the illuminance until determination is made that the subject does not have the stress.

5. The system according to claim 1, wherein:
the controller is configured to output a control signal to a lighting device or an adjustment device that adjusts brightness of the lighting device, so as to adjust the illuminance.

6. An incubator comprising:
an acquirer configured to acquire physiological information of a subject;
a determiner configured to determine whether the subject has stress or not based on the physiological information acquired by the acquirer; and
a controller configured to adjust illuminance around the subject based on a result of the determination of the determiner.

7. The incubator according to claim 6, wherein:
the physiological information is at least one of an ECG, an R-R interval, a heart rate, an SpO2, and a pulse.

8. The incubator according to claim 6, further comprising:
one or more electronic curtains, wherein
the controller is configured to adjust illuminance of the one or more electronic curtains based on a result of the determination of the determiner.

9. An illuminance adjusting method comprising:
acquiring physiological information of a subject;
determining whether the subject has stress or not based on the acquired physiological information; and
adjusting illuminance around the subject when determination has been made that the subject has the stress.
